(19) United States
(12) Patent Application Publication
(10) Pub. No.: US 2026/0118950 A1
(43) Pub. Date: Apr. 30, 2026

(54) PROCESSING SYSTEM, PROCESSING METHOD, AND STORAGE MEDIUM THEREOF

(71) Applicant: DENSO CORPORATION, Kariya-city (JP)

(72) Inventors: KIYOTO NOGUCHI, Kariya-city (JP); YUKO KANDA, Kariya-city (JP); CHIHIRO MIYAI, Kariya-city (JP); KEI NAKANO, Kariya-city (JP)

(21) Appl. No.: 19/421,712

(22) Filed: Dec. 16, 2025

Related U.S. Application Data
(63) Continuation of application No. PCT/JP2024/018615, filed on May 21, 2024.

(30) Foreign Application Priority Data
Jun. 28, 2023 (JP) 2023-106120

(51) Int. Cl. G06F 3/01; G06T 19/00

(52) U.S. Cl. CPC G06F 3/011; G06T 19/00

(57) ABSTRACT

A processing system is configured to monitor a visible area viewed by a user; adjust an occupancy rate of a display target range for displaying, in superimposed manner as an XR image, a content image to the visible area according to a risk level in the visible area; acquire, for an external sensing space of the visible area, external sensing information sensed by an autonomous mobile device that guides the user to move toward the visible area; recognize the risk level in the visible area based on the acquired external sensing information; and in response to the risk level in a hazard space portion of the external sensing space increasing to a predetermined hazard level that requires a hazard notification, adjust the occupancy rate of the display target range relative to the visible area by prohibiting a superimposed display of the content image in the hazard space portion.

### CROSS REFERENCE TO RELATED APPLICATIONS

The present application is a continuation application of International Patent Application No. PCT/JP2024/018615 filed on May 21, 2024, which designated the U.S. and claims the benefit of priority from Japanese Patent Application No. 2023-106120 filed on Jun. 28, 2023. The entire disclosures of all of the above applications are incorporated herein by reference.

### TECHNICAL FIELD

The present disclosure relates to a technology for displaying extended reality (XR) images to a user.

### BACKGROUND

There has been known a head mounted display (HMD) that provides a user virtual experience by displaying XR images as VR video. In particular, this technology makes the display of HMD transparent when the HMD detects a risk of collision in a physical environment due to the user's movement exceeding a limit range or a limit position.

### SUMMARY

According to an aspect of the present disclosure, a processing system executes an extended reality (XR) display related process for displaying an XR image to a user who is in a moving state. The processing system includes at least one of (i) a circuit and (ii) a processor with a memory storing computer program code executable by the processor. The at least one of the circuit and the processor is configured to cause the processing system to monitor a visible area, which is visible by the user through a wearable terminal worn by the user. The at least one of the circuit and the processor is configured to cause the processing system to adjust an occupancy rate of a display target range for displaying a content image relative to the visible area in accordance with a risk level in the visible area. The content image is superimposed on the visible area as the XR image in response to a content required by the user. The at least one of the circuit and the processor may be configured to cause the processing system to acquire, for an external sensing space that is a part of the visible area, external sensing information sensed by an autonomous mobile device, which guides the user to move toward the visible area, and recognize the risk level in the visible area based on the acquired external sensing information. In the external sensing space, in response to the risk level in a hazard space portion increasing to a predetermined hazard level that requires a hazard notification to the user, he at least one of the circuit and the processor maybe configured to cause the processing system to adjust the occupancy rate of the display target range relative to the visible area by prohibiting a superimposed display of the content image in the hazard space portion.

### BRIEF DESCRIPTION OF DRAWINGS

The present disclosure will become apparent from the following detailed description made with reference to the accompanying drawings. In the drawings:

FIG. 1 is a diagram showing an overall configuration of a network connection environment of a processing system according to a first embodiment;

FIG. 2 is a schematic diagram showing a wearable terminal according to the first embodiment;

FIG. 3 is a schematic diagram for explaining three-dimensional voxels arranged in an infrastructure system according to the first embodiment;

FIG. 4 is a block diagram showing a processing system according to the first embodiment;

FIG. 5 is a flowchart showing a processing procedure according to the first embodiment;

FIG. 6 is a flowchart showing an adjustment subroutine of the processing flow according to the first embodiment;

FIG. 7 is a schematic diagram showing a display state of the wearable terminal according to the first embodiment;

FIG. 8 is a schematic diagram showing a display state of the wearable terminal according to the first embodiment;

FIG. 9 is a schematic diagram showing a display state of the wearable terminal according to the first embodiment;

FIG. 10 is a schematic diagram for explaining an adjustment subroutine according to the first embodiment;

FIG. 11 is a schematic diagram for explaining an adjustment subroutine according to the first embodiment;

FIG. 12 is a diagram showing a configuration of network connection environment of a processing system according to a second embodiment;

FIG. 13 is a schematic diagram showing a mobile terminal according to the second embodiment;

FIG. 14 is a block diagram showing a processing system according to the second embodiment;

FIG. 15 is a flowchart showing a processing flow according to the second embodiment;

FIG. 16 is a flowchart showing an adjustment subroutine of the processing flow according to the second embodiment;

FIG. 17 is a schematic diagram showing a display state of the mobile terminal according to the second embodiment;

FIG. 18 is a schematic diagram showing a display state of the mobile terminal according to the second embodiment;

FIG. 19 is a schematic diagram showing a display state of the mobile terminal according to the second embodiment;

FIG. 20 is a schematic diagram for explaining an adjustment subroutine according to the second embodiment; and

FIG. 21 is a schematic diagram for explaining an adjustment subroutine according to the second embodiment.

### DETAILED DESCRIPTION

In the above-described related art, the movement of user who wears the HMD is used as a trigger, and the limit position causing the collision risk is set based on the user's position. Thus, a range in which safety can be ensured by switching to transparent display is limited to the user's proximity. As a result, when all VR images disappear by switching to transparent display, this display switch will disrupt a continuity of virtual experience, particularly when applied to a user who is in a moving state.

According to a first aspect of the present disclosure, a processing system executes an extended reality (XR) display related process for displaying an XR image to a user who is in a moving state. The processing system includes at least one of (i) a circuit and (ii) a processor with a memory storing computer program code executable by the processor. The at least one of the circuit and the processor is configured to cause the processing system to: monitor a visible area, which is visible by the user through a wearable terminal worn by the user; adjust an occupancy rate of a display target range for displaying a content image relative to the visible area in accordance with a risk level in the visible area, the content image being superimposed on the visible area as the XR image in response to a content required by the user; acquire, for an external sensing space that is a part of the visible area, external sensing information sensed by an autonomous mobile device, which guides the user to move toward the visible area; recognize the risk level in the visible area based on the acquired external sensing information; and in the external sensing space, in response to the risk level in a hazard space portion increasing to a predetermined hazard level that requires a hazard notification to the user, adjust the occupancy rate of the display target range relative to the visible area by prohibiting a superimposed display of the content image in the hazard space portion.

According to a second aspect of the present disclosure, a processing method is executed by a processor for performing an extended reality (XR) display related process that displays an XR image to a user who is in a moving state. The processing method includes: monitoring a visible area, which is visible by the user through a wearable terminal worn by the user; adjusting an occupancy rate of a display target range for displaying a content image relative to the visible area in accordance with a risk level in the visible area, the content image being superimposed on the visible area as the XR image in response to a content required by the user; acquiring, for an external sensing space that is a part of the visible area, external sensing information sensed by an autonomous mobile device, which guides the user to move toward the visible area; recognizing the risk level in the visible area based on the acquired external sensing information; and in the external sensing space, in response to the risk level in a hazard space portion increasing to a predetermined hazard level that requires a hazard notification to the user, adjusting the occupancy rate of the display target range relative to the visible area by prohibiting a superimposed display of the content image in the hazard space portion.

According to a third aspect of the present disclosure, a non-transitory computer readable storage medium stores a processing program for performing an extended reality (XR) display related process that displays an XR image to a user who is in a moving state. The processing program includes instructions for causing a processor to: monitor a visible area, which is visible by the user through a wearable terminal worn by the user; adjust an occupancy rate of a display target range for displaying a content image relative to the visible area in accordance with a risk level in the visible area, the content image being superimposed on the visible area as the XR image in response to a content required by the user; acquire, for an external sensing space that is a part of the visible area, external sensing information sensed by an autonomous mobile device, which guides the user to move toward the visible area; recognize the risk level in the visible area based on the acquired external sensing information; and in the external sensing space, in response to the risk level in a hazard space portion increasing to a predetermined hazard level that requires a hazard notification to the user, adjust the occupancy rate of the display target range relative to the visible area by prohibiting a superimposed display of the content image in the hazard space portion.

In the above-described first to third aspects, the visible area, which is visually recognizable by the user through the wearable terminal worn by the user, is monitored. Further, in the content image superimposed on the visible area as the XR image according to the content required by the user, the occupancy rate of the display target range relative to the visible area is adjusted according to the risk level in the visible area.

According to the first to third aspects, the external sensing information sensed by the autonomous mobile device, which guides the user who moves toward the visible area, is acquired, and the risk level based on the external sensing information is recognized. This configuration allows effective use of the autonomous mobile device, which guides the user, to recognize the risk level within a wide range with respect to the visible area toward which the user is moving, thereby ensuring the user's safety.

According to the first to third aspects, the visible area includes the external sensing space, which is a spatial range for which the external sensing information is acquired. Within the external sensing space, superimposed display of the content image is prohibited in the hazard space portion where the risk level has reached the hazard level. According to this configuration, the content image disappears only within the hazard space portion, which reaches the hazard level and thus requires hazard notification to the user who is in the moving state. Further, the occupancy rate can be adjusted so that the content image continues to be superimposed on the remaining portion of the visible area outside the hazard space portion. Therefore, it is possible to balance the safety of moving user with the continuity of virtual experience.

According to a fourth aspect of the present disclosure, a processing system executes an extended reality (XR) display related process for displaying an XR image to a user who is in a moving state. The processing system includes at least one of (i) a circuit and (ii) a processor with a memory storing computer program code executable by the processor. The at least one of the circuit and the processor is configured to cause the processing system to: monitor a background area, which is displayed as background video of a mobile terminal when the user who carries the mobile terminal is oriented to the mobile terminal; adjust an occupancy rate of a display target range for displaying a content image relative to the background area in accordance with a risk level in the background area, the content image being superimposed on the background area as the XR image in response to a content required by the user; acquire, for an external sensing space that is a part of the background area, external sensing information sensed by an autonomous mobile device, which guides the user to move toward the background area; recognize the risk level in the background area based on the acquired external sensing information; and in the external sensing space, in response to the risk level in a hazard space portion increasing to a predetermined hazard level that requires a hazard notification to the user, adjust the occupancy rate of the display target range relative to the background area by prohibiting a superimposed display of the content image in the hazard space portion.

According to a fifth aspect of the present disclosure, a processing method is executed by a processor for performing an extended reality (XR) display related process that displays an XR image to a user who is in a moving state. The processing method includes monitoring a background area, which is displayed as background video of a mobile terminal when the user who carries the mobile terminal is oriented to the mobile terminal; adjusting an occupancy rate of a display target range for displaying a content image relative to the background area in accordance with a risk level in the background area, the content image being superimposed on the background area as the XR image in response to a content required by the user; acquiring, for an external sensing space that is a part of the background area, external sensing information sensed by an autonomous mobile device, which guides the user to move toward the background area; recognizing the risk level in the background area based on the acquired external sensing information; and in the external sensing space, in response to the risk level in a hazard space portion increasing to a predetermined hazard level that requires a hazard notification to the user, adjusting the occupancy rate of the display target range relative to the background area by prohibiting a superimposed display of the content image in the hazard space portion.

According to a sixth aspect of the present disclosure, a non-transitory computer readable storage medium stores a processing program for performing an extended reality (XR) display related process that displays an XR image to a user who is in a moving state. The processing program includes instructions for causing a processor to: monitor a background area, which is displayed as background video of a mobile terminal when the user who carries the mobile terminal is oriented to the mobile terminal; adjust an occupancy rate of a display target range for displaying a content image relative to the background area in accordance with a risk level in the background area, the content image being superimposed on the background area as the XR image in response to a content required by the user; acquire, for an external sensing space that is a part of the background area, external sensing information sensed by an autonomous mobile device, which guides the user to move toward the background area; recognize the risk level in the background area based on the acquired external sensing information; and in the external sensing space, in response to the risk level in a hazard space portion increasing to a predetermined hazard level that requires a hazard notification to the user, adjust the occupancy rate of the display target range relative to the background area by prohibiting a superimposed display of the content image in the hazard space portion.

In the fourth to sixth aspects, the background area, which is displayed to the user on the mobile terminal carried by the user, is monitored. Therefore, in the content image superimposed as the XR image according to the content required by the user on the background video displaying the background area, the occupancy rate of the display target range of content image relative to the background video is adjusted according to the risk level in the background area.

According to the fourth to sixth aspects, the external sensing information sensed by the autonomous mobile device, which guides the user who moves toward the background area, is acquired, and the risk level based on the external sensing information is recognized. This configuration allows effective use of the autonomous mobile device, which guides the user, to recognize the risk level within a wide range with respect to the background area toward which the user is moving, thereby ensuring the user's safety.

According to the fourth to sixth aspects, the background area, which is displayed as the background video, includes the external sensing space, which is a spatial range for which the external sensing information is to be acquired. Within the external sensing space, which is displayed as a part of the background video, superimposed display of the content image is prohibited for the hazard space where the risk level has reached the hazard level. According to this configuration, in the background video, the content image disappears only within a portion corresponding to the hazard space, which reaches the hazard level and thus requires hazard notification to the user who is in the moving state. Further, the occupancy rate can be adjusted so that the content image continues to be superimposed on the remaining portion of the background area outside the portion corresponding to the hazard space. Therefore, it is possible to balance the safety of moving user with the continuity of virtual experience.

The following will describe embodiments of the present disclosure with reference to the drawings. It should be noted that the same reference symbol is assigned to corresponding components in the respective embodiments, and repeated description may be omitted. When only a part of the configuration is described in each embodiment, the remaining configuration described in the foregoing embodiment may be applied to the remaining part of the configuration. Further, not only the combinations of the configurations explicitly shown in the description of the respective embodiments, but also the configurations of the multiple embodiments can be partially combined together even if the configurations are not explicitly shown if there is no contradiction in the combination in particular.

### First Embodiment

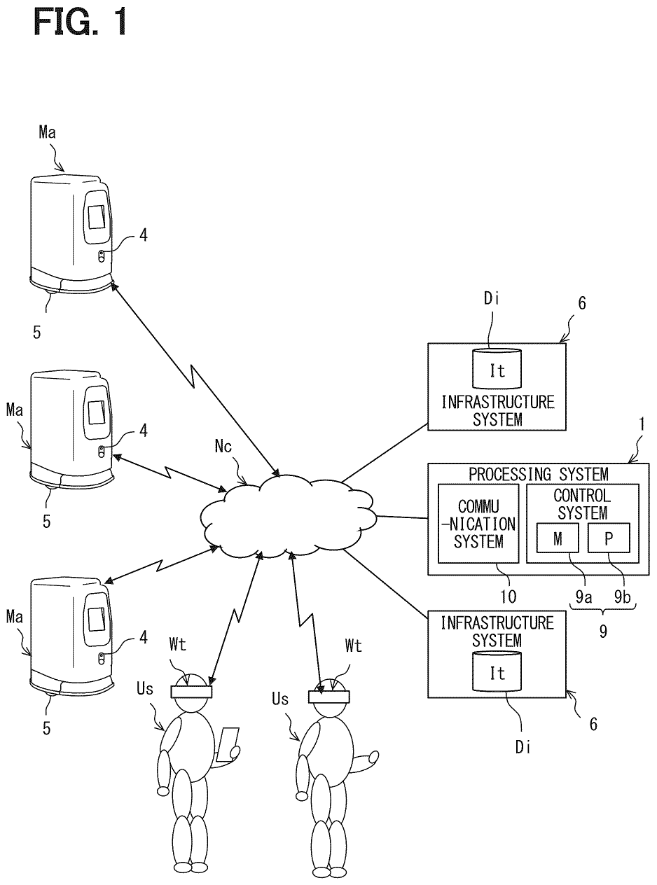

A processing system 1 according to the first embodiment shown in FIG. 1 performs XR display related processing for displaying XR images to a moving user Us in conjunction with providing a user service to the user Us. The processing system 1 is connected, via a communication network Nc, to a wearable terminal Wt worn by a pre-registered user Us, an autonomous mobile device Ma, and an infrastructure system 6. At least one of the wearable terminal Wt, the autonomous mobile device Ma, or the infrastructure system 6 is connected to the processing system 1.

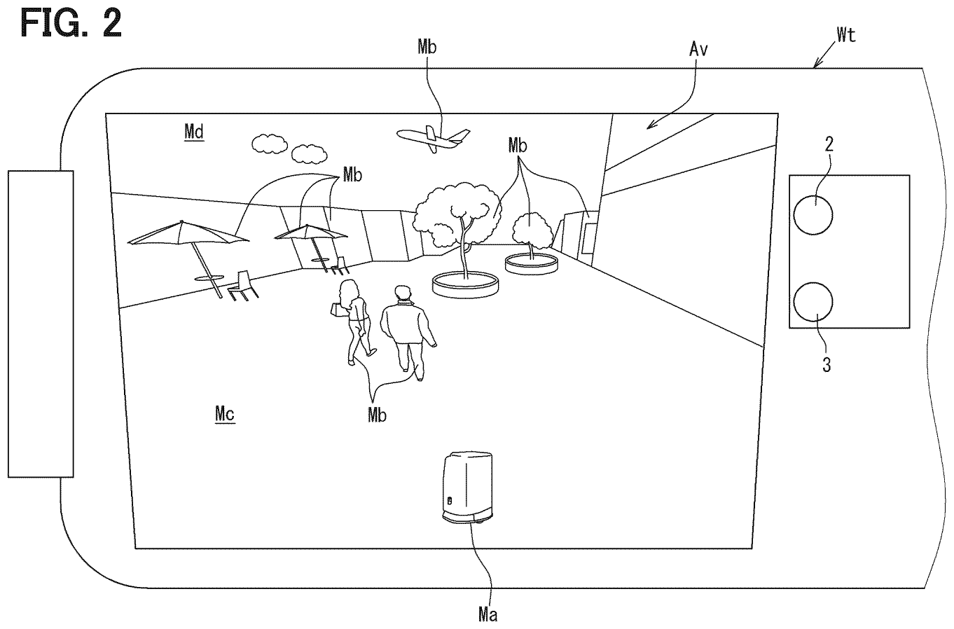

The wearable terminal Wt is configured to be wearable on the face of user Us and can be operated hands-free, at least when connected to the processing system 1. As shown in FIG. 2, the wearable terminal Wt is an optical see-through electronic device equipped with a display unit 2 and a sensor unit 3. For example, the wearable terminal Wt may be an HMD or smart glasses. FIG. 2 is a schematic image showing the visible area Av viewed from the user Us through the wearable terminal Wt in a portion corresponding to one eye among both eyes of the user Us.

As shown in FIG. 1, the wearable terminal Wt controls transmission and reception of data via the communication network Nc using a communication unit. The operation of wearable terminal Wt is controlled by a control unit in accordance with control commands transmitted from the processing system 1 via the communication network Nc so that the wearable terminal Wt performs XR display related process in cooperation with the processing system 1.

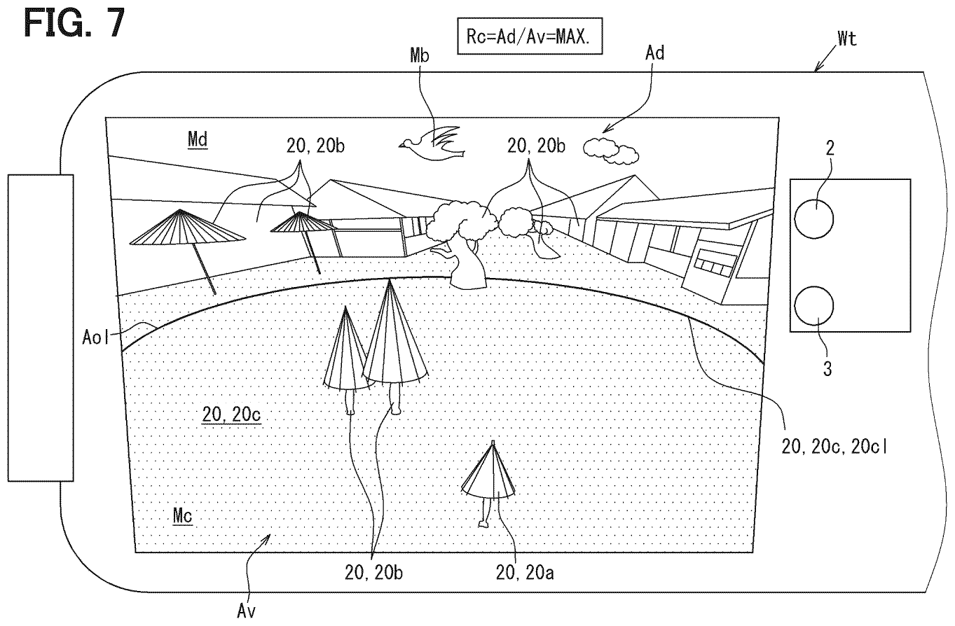

Under the control of the control unit of the wearable terminal Wt, the display unit 2 shown in FIG. 2, such as a virtual image projection type or a retinal projection type, superimposes a display (see FIG. 7 to FIG. 9 to be described later) necessary for the XR display related process on a real image of the visible area Av visually recognized by the user Us, through a glass or a lens, and causes the user Us to visually recognize the superimposed display. At the same time, under the operation control of the wearable terminal Wt, the sensor unit 3 shown in FIG. 2 acquires sensing information by performing sensing process corresponding to the XR display related process. The sensor unit 3 may be at least one of a camera, an inertial sensor, a GNSS sensor, an electrooculography sensor, a line of sight sensor, an infrared sensor, a geomagnetic sensor, a motion sensor, a touch sensor, and a microphone. With such a configuration, the sensor unit 3 can acquire an input indicating an intention of the user Us as the sensing information.

The autonomous mobile device Ma shown in FIG. 1 is an autonomous traveling vehicle or an autonomous traveling robot capable of autonomously traveling in any direction of front, rear, left, and right by electrically driving wheels 5 based on sensing information acquired by a sensor unit 4. The autonomous mobile device Ma controls transmission and reception of data via the communication network Nc by a communication unit. The autonomous mobile device Ma is driven and controlled by a control unit in accordance with a control command from the processing system 1 via the communication network Nc so that the autonomous mobile device Ma performs XR display related processing in cooperation with the processing system 1. Under this drive control, the sensor unit 4 acquires the sensing information by performing the sensing process corresponding to the XR display related processing. The sensor unit 4 may be at least one of a camera, an inertial sensor, a GNSS sensor, a light detection and ranging/laser imaging detection and ranging (LiDAR), and a sonar.

The infrastructure system 6 is a platform system that serves as a common platform for a distributed architecture and shares three-dimensional spatial information It stored in an infrastructure database Di. The infrastructure system 6 controls transmission and reception of data via the communication network Nc by a communication unit. The infrastructure system 6 collects, by the control unit at appropriate time, the three-dimensional spatial information It to be provided to an individual distributed system such as the processing system 1 constituting the distributed architecture, and updates the stored information of the infrastructure database Di to the latest information.

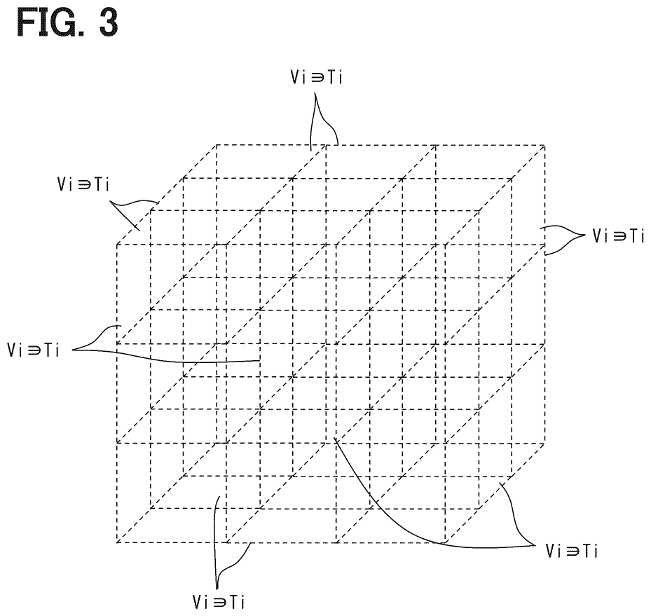

The infrastructure system 6 manages information by virtually dividing a three-dimensional space in which information is to be stored into multiple three-dimensional voxels Vi (that is, three-dimensional grids) arranged in a three-dimensional array as shown in FIG. 3. The infrastructure system 6 stores a data set associated with each space ID individually assigned to each voxel Vi by metadata as the three-dimensional spatial information It in the infrastructure database Di as shown in FIG. 1. The three-dimensional spatial information It may include two-dimensional grid information associated with, for example, only a lower surface of the voxel Vi constituting a lowermost layer of a two-dimensional array along the ground among the three-dimensional array.

The data constructing the three-dimensional spatial information It may be collected from at least one of the wearable terminal Wt that cooperates with the processing system 1, other wearable terminals, or a mobile terminal such as a smartphone or a tablet terminal. The data constructing the three-dimensional spatial information It may be collected from at least one of the autonomous mobile device Ma that cooperates with the processing system 1 or other moving objects.

The data constructing the three-dimensional spatial information It may be collected from at least one of a communication base station, a smart pole, a smart street light, each of which includes an infrastructure sensor such as a camera and/or a LiDAR. The data constructing the three-dimensional spatial information It may be collected from a service provider that provides at least one of, for example, a map service, a weather service, a communication service, a traffic management service, a planimetric feature management service, an aircraft management service, and a user service provided by the processing system 1. The user service provided by the processing system will be described later.

The construction data collected in the above-described manner to construct the three-dimensional spatial information It may be at least one type of image data among, for example, a video, a still image, or a point cloud image. The construction data of the three-dimensional spatial information It may be at least one type of secondary data for which information security is ensured among, for example, position data, motion data, posture data, gaze data, action data, and people flow data generated for humans including the user Us of the processing system 1 in a target space for information storage by image processing of such image data, and intention data representing an intention of the user Us to be described later.

The construction data of the three-dimensional spatial information It may be at least one type of secondary data among, for example, position data, motion data, and posture data generated by image processing of image data regarding human belongings including the wearable terminal Wt of the user Us in an information storage target space. The construction data of the three-dimensional spatial information It may be at least one type of secondary data among, for example, position data, motion data, and posture data generated by image processing of image data regarding a moving object including the autonomous mobile device Ma in the information storage target space.

The construction data of the three-dimensional spatial information It may be speech data obtained by collecting speeches of humans including the user Us of the processing system 1 in the information storage target space. The construction data of the three-dimensional spatial information It may be at least one type of secondary data for which information security is ensured among, for example, position data, motion data, action data, people flow data, conversation data, which are analyzed with respect to humans including the user Us by speech recognition processing of such speech data, and intention data representing an intention of the user Us to be described later.

The construction data of the three-dimensional spatial information It may be, for example, at least one type of two-dimensional and/or three-dimensional map data, geographic information system (GIS) data, road network data, weather data, communication data, line data, traffic data, feature management data, building information modeling (BIM) data, point of interest (POI) data, air management data, and time data. The construction data of the three-dimensional space information It may be service data related to at least one of the user services handled by the processing system 1, such as a guidance service, a transportation service, a photography service, and an online game service, which will be described later.

As shown in FIG. 1, the processing system 1 is a distributed computer system including a communication system 10 and a control system 9, and constructed to include at least one of, for example, a cloud server and an edge server. At least a portion of the communication system 10 and at least a portion of the control system 9 in the processing system 1 may include the communication unit and the control unit of the wearable terminal Wt, respectively. At least a portion of the communication system 10 and at least a portion of the control system 9 in the processing system 1 may include the communication unit and the control unit of the autonomous mobile device Ma, respectively. At least a portion of the communication system 10 and at least a portion of the control system 9 in the processing system 1 may include the communication unit and the control unit of the infrastructure system 6, respectively.

The communication system 10 mainly includes a communication device for performing a communication through the communication network Nc. The control system 9 is connected to the communication system 10 via at least one of a wired communication line or a wireless communication line. The control system 9 includes at least one dedicated computer. The dedicated computer constituting the control system 9 includes at least one memory 9a and at least one processor 9b.

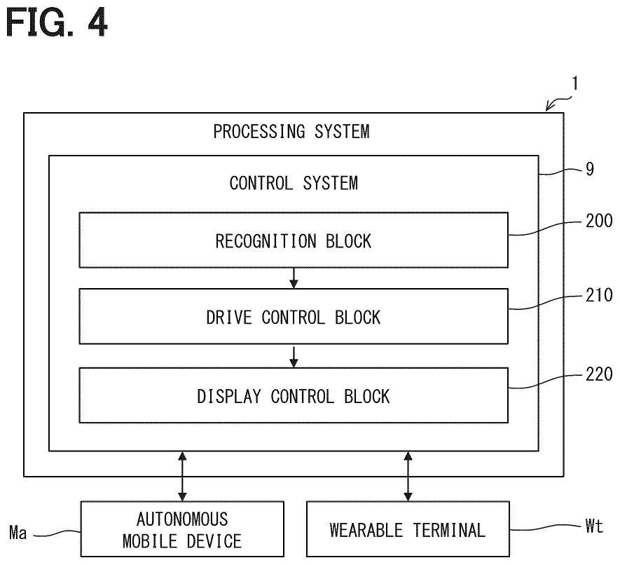

In the processing system 1, the control system 9 causes the processor 9b to execute multiple instructions of a processing program stored in the memory 9a. As a result, the control system 9 functions as multiple functional blocks for performing the XR display related process. As shown in FIG. 4, the functional blocks of the control system include a recognition block 200, a drive control block 210, and a display control block 220.

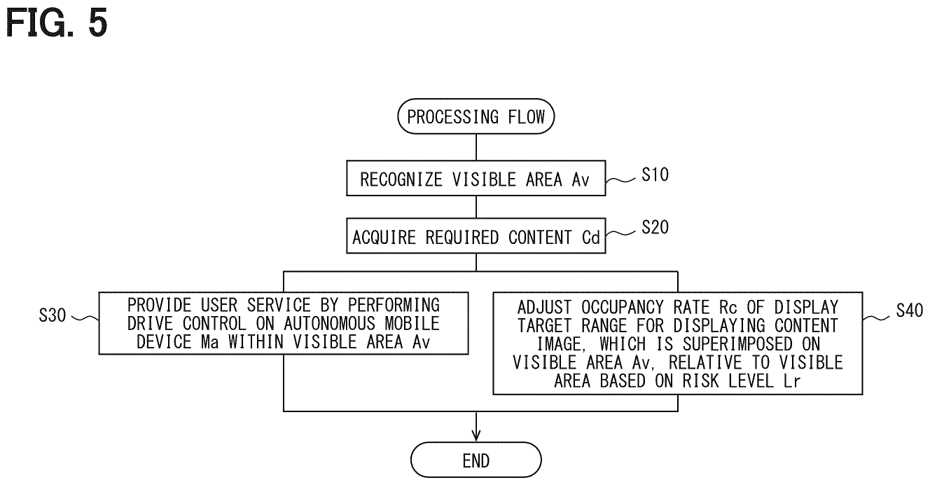

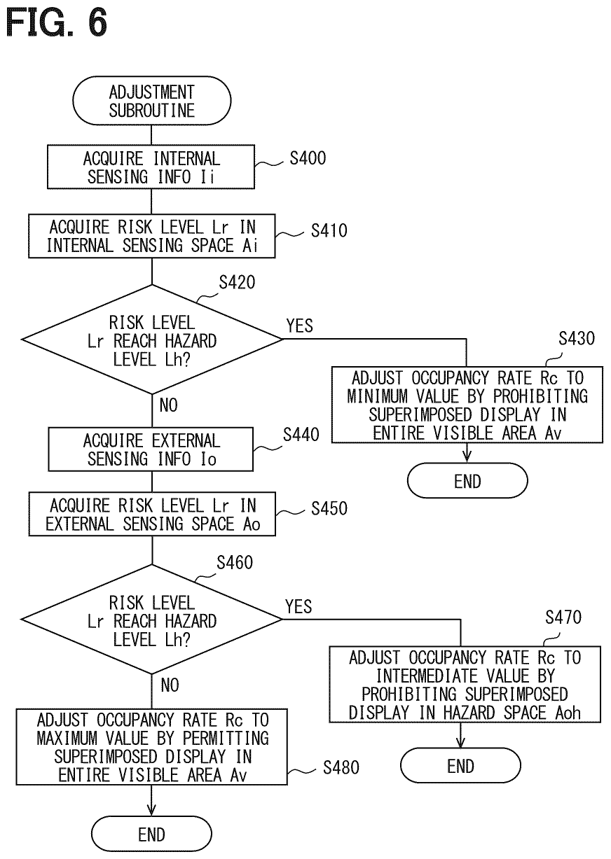

The following will describe a processing method in which the processing system 1 performs the XR display related process by cooperation of these blocks 200, 210, and 220 with reference to the processing flow shown in FIG. 5 and FIG. 6. This processing flow is executed in response to the sensor unit 3 of the wearable terminal Wt acquiring, as the sensing information, a service request input by the user Us. The service request is a request for providing a user service intended by the user. Each “S” in the processing flow indicates multiple steps executed by multiple instructions included in the processing program of the first embodiment.

In S10 of the processing flow shown in FIG. 5, the recognition block 200 (see FIG. 4) monitors the visible area Av visually recognized by the user Us through the wearable terminal Wt. The visible area Av is monitored based on at least one type of sensing information from the sensor unit 3 of the wearable terminal Wt, such as camera information and inertial information. As a result, the visible area Av is recognized as an area extending in a direction toward which the face or gaze of the user Us faces or a direction toward which the wearable terminal Wt faces. During the execution of each step subsequent to S10 of the processing flow, the latest recognized visible area Av may be updated by executing a monitoring process of the visible area Av in parallel as the visible area Av changes due to the movement of the user Us.

In S20 of the processing flow shown in FIG. 5, the recognition block 200 acquires a required content Cd according to the intention of the user Us. The required content Cd is recognized based on the sensing information about the face of user Us acquired by the wearable terminal Wt worn on the face of the user. The sensing information for recognizing the required content Cd is acquired through the wearable terminal Wt at a timing when the sensing information is input to the sensor unit 3 as the intention data indicating an intention of the user Us.

As the input of required content Cd in S20, gesture input, gaze input, facial expression input, or speech input by the user Us may be sensed by the sensor unit 3. On the display unit 2 of the wearable terminal Wt, an XR image for receiving input of the required content Cd from the user Us via the sensor unit 3 may be superimposed on the visible area Av of the wearable terminal Wt. The required content Cd may be recognized based on the three-dimensional spatial information It obtained from the infrastructure database Di through the communication system 10.

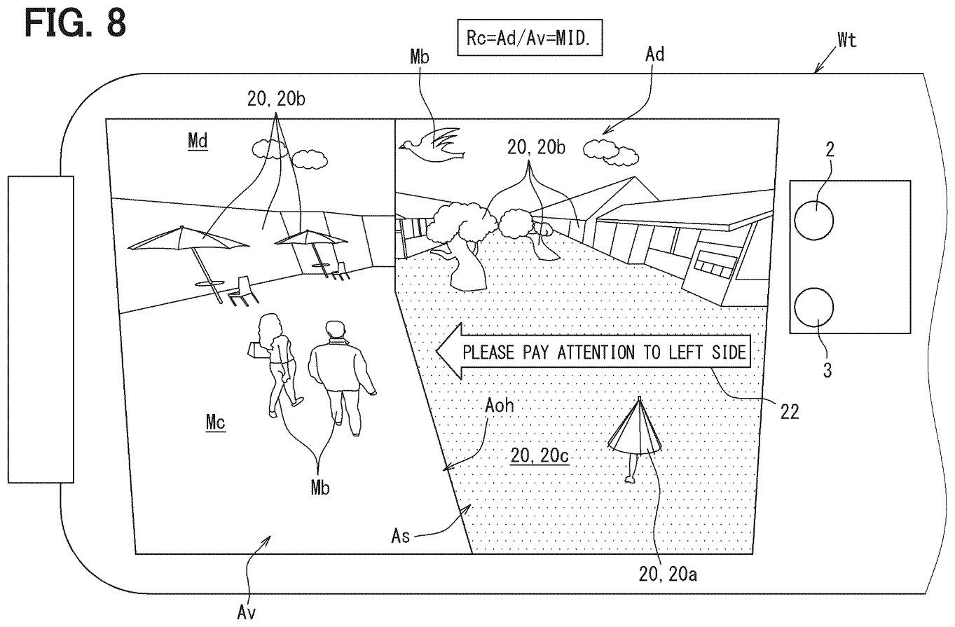

The required content Cd recognized in S20 may include at least a display theme to be added to the XR image (image 20 shown in FIG. 7 and FIG. 8 to be described below) displayed by the display unit 2 of the wearable terminal Wt in conjunction with the provision of user services to the user Us. The display theme indicates a concept common to the XR images, whether they are two-dimensional or three-dimensional representations, such as virtual or real living things, such as monsters, animals, plants, and insects, as well as inanimate objects, such as prehistoric buildings, service vehicles, and fantasy objects.

The item of required content Cd recognized in S20 may include types of user services that can be provided to the user Us through use of the autonomous mobile device Ma. As the type of user services, at least one type is prepared from, for example, a guidance service, a transport service, a photography service, an online game service, and the like.

In S20, for any user service, the required content Cd may include at least one route related item, such as the route including the destination, the travel pace, the arrival time, and the service provision time (that is, the guidance time or the transport time). In S20, for any user service, the required content Cd may include at least one voice related item, such as whether or not voice output is required, whether or not a voice recognition function is required, and whether or not a dialogue function is required.

In S20, in the case of guidance service, the required content Cd may include at least one type of tourism related item, such as the acceptable level of congestion, the presence or absence of facilities required by the user, and the presence or absence of nature, for a destination such as a tourist spot. In S20, in the case of delivery service, the required content Cd may include at least one of the items related to a load, such as the number, size, weight, type, and whether or not temperature control is required.

In S20, in the case of photography service, the required content Cd may include at least one photography related item such as a photography schedule, photography timing, photography location, whether or not to send images or data, and whether or not to print photos. In S20, in the case of online game service, the required content Cd may include at least one of the following game related items, for example, initial settings for game characters, environmental settings for the online game, difficulty level of the online game, whether or not to send images, and whether a game match is required or not.

In S30 of the processing flow shown in FIG. 5, the drive control block 210 (see FIG. 4) drives the autonomous mobile device Ma within the visible area Av, thereby providing a user service. A drive control pattern for the autonomous mobile device Ma that matches the type is read from the memory 9a, and the user service is provided in accordance with the drive control pattern so as to guide the user Us to move toward the visible area Av.

The guidance service in S30 is provided according to a drive control pattern for route guidance in which the autonomous mobile device Ma is driven from a standby position to a position in the vicinity of the user Us, and guides the user Us to the destination. In the guidance service, a route for guiding the user Us may be presented by superimposing and displaying an XR image on the visible area Av in the wearable terminal Wt or by display output from the display unit equipped to the autonomous mobile device Ma. In the guidance service, the route for guiding the user Us may be presented by audio guidance output from an audio unit equipped to the wearable terminal Wt or the autonomous mobile device Ma.

The transportation service by S30 is provided according to a drive control pattern in which the autonomous mobile device Ma having a loading compartment is driven from a waiting position to a position in the vicinity of the user Us, and the load housed in the loading compartment is transported to the destination together with the leading user. In the transportation service, a method for inputting the load into the loading chamber may be presented to the user Us by superimposing and displaying the XR image on the visible area Av equipped to the wearable terminal Wt or by the display output from the display unit of the autonomous mobile device Ma. In the transportation service, the method for inputting the load into the loading chamber may be presented to the user Us by the audio guidance output from the audio unit equipped to the wearable terminal Wt or the autonomous mobile device Ma.

In S30, the photography service is provided according to a drive control pattern in which the autonomous mobile device Ma having the image capturing is driven from a standby position to a position in the vicinity of the user Us, and captures images around the leading user. In the photography service, the image capturing schedule or the image capturing timing may be presented to the user Us by superimposing and displaying the XR image on the visible area Av in the wearable terminal Wt or by the display output from the display unit of the autonomous mobile device Ma. In the photography service, the image capturing schedule or the image capturing timing may be presented to the user Us by the audio guidance output from the audio unit equipped to the wearable terminal Wt or the autonomous mobile device Ma.

In the photography service, a two-dimensional or three-dimensional still image or video may be captured to include the user Us by the autonomous mobile device Ma driven around the user Us. In the photography service, the focus for photographing may be adjusted based on a distance to the user Us sensed by the sensor unit 4, such as a LiDAR in the autonomous mobile device Ma. In the photography service, the incident direction of external light during photography may be adjusted based on three-dimensional spatial information It obtained from the infrastructure database Di, or sensing information acquired from the sensor unit 4, such as a camera included in the autonomous mobile device Ma. In the photography service, image data of the user Us may be stored in the memory 9a of the control system 9 or in a storage medium of the wearable terminal Wt.

In S30, the online game service is provided according to a drive control pattern in which the autonomous mobile device Ma is driven from a standby position to a position in the vicinity of the user Us, and leads the user U to a capture point in the online game. In the online game service, necessary instructions for the online game may be presented to the user Us by superimposing an XR image on the visible area Av of the wearable terminal Wt, or by display output from a display unit of the autonomous mobile device Ma. In the online game service, necessary instructions for the online game may be presented to the user Us by audio guidance output from an audio unit equipped to the wearable terminal Wt or the autonomous mobile device Ma.

The processing flow shown in FIG. 5 executes S40 in parallel with S30. In S40, the display control block 220 (see FIG. 4) causes the display unit 2 of the wearable terminal Wt to superimpose an XR image corresponding to the required content Cd on the visible area Av of the autonomous mobile device Ma, which provides the user service in S30. The display control block 220 adjusts an occupancy rate Rc of a display target range Ad relative to the visible area Av according to a risk level Lr in the visible area Av. The display target range Ad is a range of the content image 20 of the XR image, which is superimposed according to the required content Cd as shown in FIG. 7 and FIG. 8. The occupancy rate Rc in the first embodiment may indicate a ratio of a display area of the entire display target range Ad relative to the two-dimensional projection area of the entire visible area Av, visible through the glasses, lenses, retina, etc. of the display unit 2.

In S40, the content image 20 includes at least a device image 20a shown in FIG. 7 and FIG. 8 as an XR image superimposed on the autonomous mobile device Ma in the visible area Av. The visible area Av is shown in FIG. 2. The superimposed display position of the device image 20a is adjusted to match the predicted view position of the autonomous mobile device Ma in accordance with the drive control pattern in S30. The display position adjustment at this time is based on information obtained from the infrastructure database Di via the communication system 10 as three-dimensional space information It to which position related information of the autonomous mobile device Ma is added for each voxel Vi in the user service provision space. As a result, a superimposed display in which the device image 20a with a display theme corresponding to the required content Cd is superimposed on the autonomous mobile device Ma is displayed to the user so as to obscure the entire autonomous mobile device Ma opaquely or semi-transparently from in front of the autonomous mobile device.

In S40, the content image 20 may include an object image 20b shown in FIG. 7 and FIG. 8 as the XR image superimposed on another object Mb visible in the visible area Av together with the autonomous mobile device Ma as shown in FIG. 2. The superimposed display position of the object image 20b is adjusted to match the predicted view position of another object Mb, so that the object image 20b is displayed in an overlapping manner similar to the device image 20a. Another object Mb on which the object image 20b is overlapped and displayed in the overlapped manner are expected to be, for example, at least one of the following: a person other than the user Us of the processing system 1, a moving body other than the autonomous mobile device Ma that cooperates with the processing system 1, an aircraft, a structure, and plantings.

In S40, as shown in FIG. 7 and FIG. 8, the content image 20 may include a ground image 20c as the XR image superimposed on the ground Mc visible in the visible area Av together with the autonomous mobile device Ma shown in FIG. 2. The superimposed display position of the ground image 20c is adjusted to match the predicted view position of the ground Mc, so that the device image 20a is displayed in an overlapping manner.

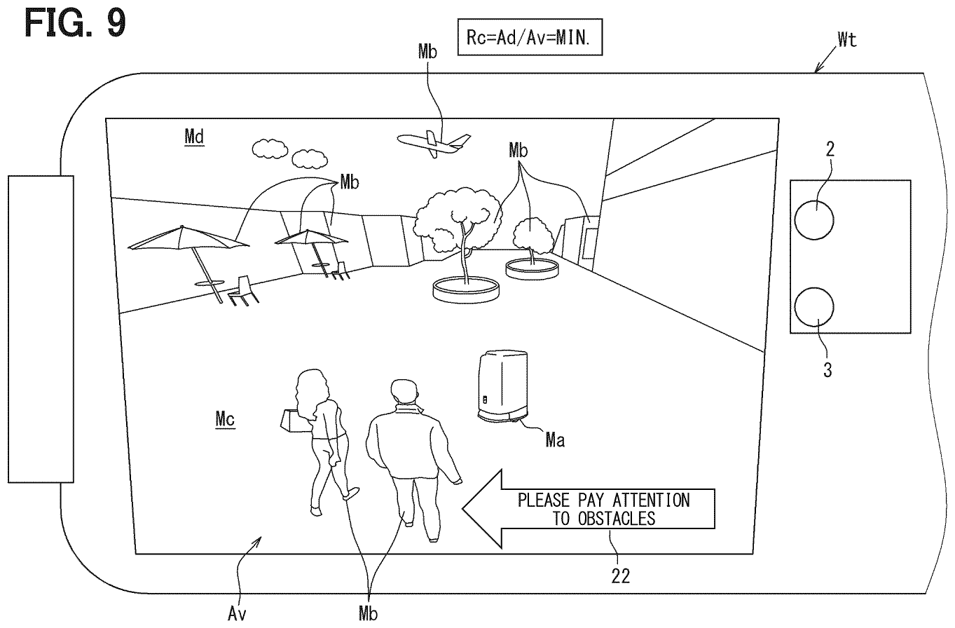

In S40, the display target range Ad of the content image 20 may be set to the entire visible area Av as shown in FIG. 7, and the occupancy rate Rc is adjusted to the maximum value (for example, 1). In S40, the display target range Ad of the content image 20 may be set to disappear from the visible area Av as shown in FIG. 9, and the occupancy rate Rc is adjusted to the minimum value (for example, 0). In S40, the display target range Ad of the content image 20 may be set to a portion of the visible area Av as shown in FIG. 8, and the occupancy rate Rc is adjusted to a value between the minimum value and the maximum value (for example, greater than 0 and less than 1).

In S40, when hazard notification to the user Us becomes necessary based on the risk level Lr, a hazard image 22, as shown in FIG. 8 and FIG. 9, may be superimposed as the XR image on the ground Mc and/or the sky Md within the visible area Av, which is shown in FIG. 2, in the display unit 2. The superimposed display position of the hazard image 22 may be adjusted to match the predicted view position on the ground Mc and/or in the sky Md. The display position adjustment of the hazard notification may be based on information obtained from the infrastructure database Di via the communication system 10 as the three-dimensional spatial information It to which position related information on the ground Mc and/or the sky Md is added for each voxel Vi in the space where the user service is provided.

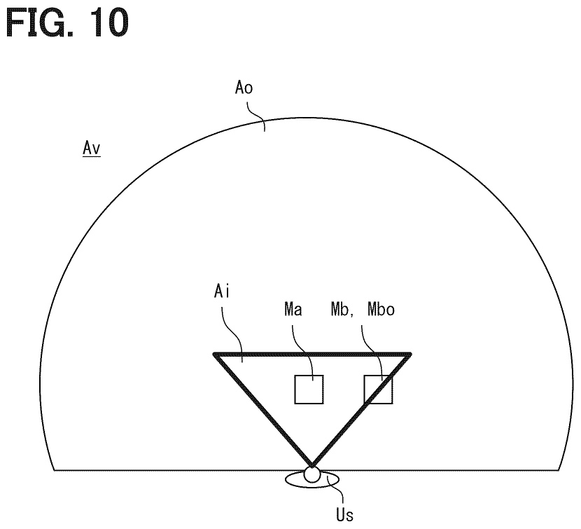

In S40, an adjustment subroutine is executed as shown in FIG. 6 to switch and adjust the occupancy rate Rc according to the risk level Lr in the visible area Av. In S400 of the adjustment subroutine, the display control block 220 acquires internal sensing information Ii sensed by the sensor unit 3 of the wearable terminal Wt. The acquisition range of the internal sensing information Ii acquired by the sensor unit 3 with an acceptable level of accuracy or reliability is set to an internal sensing space Ai, which is part of the visible area Av as shown in FIG. 10. Therefore, the internal sensing information Ii acquired for the internal sensing space Ai is obtained from at least one sensor included in the sensor unit 3, such as a camera or motion sensor.

The internal sensing space Ai in S400 is defined by multiple voxels Vi whose two-dimensional or three-dimensional distances are assumed to be within a set distance with the user Us or the wearable terminal Wt at the center. Therefore, the set distance that determines the limit range of the internal sensing space Ai is set to a fixed value such as 5 meters depending on the specification of the sensor unit 3 and/or the risk requirement for the processing system 1.

In S410 of the adjustment subroutine shown in FIG. 6, the display control block 220 acquires the risk level Lr in the internal sensing space Ai of the visible area Av. The risk level Lr is defined as an index, and is set to reach the hazard level Lh when at least a portion of an obstacle Mbo, such as a human, a moving object, or a structure, which is predicted to interfere with the movement of the user Us as shown in FIG. 10, relatively enters the internal sensing space Ai. When the obstacle Mbo disappears from the internal sensing space Ai, the risk level Lr within the internal sensing space Ai is determined to be at a safe level that is outside of the hazard level Lh.

In S420 of the adjustment subroutine shown in FIG. 6, the display control block 220 determines whether the risk level Lr in the internal sensing space Ai has reached that hazard level Lh that requires hazard notification to the moving user Us. The comparison of the risk level Lr with the hazard level Lh may be performed for each voxel Vi in the space where the user service is provided or for each voxel group consisting of multiple voxels Vi.

When a positive determination is made in S420, in S430 of the adjustment subroutine shown in FIG. 6, the display control block 220 adjusts the occupancy rate Rc to the minimum value by prohibiting the superimposed display of the content image 20 over the entire area within the visible area Av, as shown in FIG. 9, so that the entire visible area is excluded from the display target range Ad of the content image 20. In S430, a hazard image 22 notifying the driver of the risk level Lr reaching the hazard level Lh may be superimposed on the visible area Av as shown in FIG. 9 with warning text and/or a colored display for warning purpose. The hazard image 22 may be displayed to notify at least one of, for example, the position, direction, distance, and type of the obstacle Mbo that caused the hazard level Lh in the internal sensing space Ai.

In addition to displaying the hazard image 22, in S430, a warning indicating that the risk level Lr has reached the hazard level Lh may be issued by display output from a display unit of the autonomous mobile device Ma or output of a warning light. In S430, a warning that the risk level Lr has reached the hazard level Lh may be output as an audio signal from the display unit of the autonomous mobile device Ma. Upon completion of S430, the current execution of the adjustment subroutine and processing flow is completed.

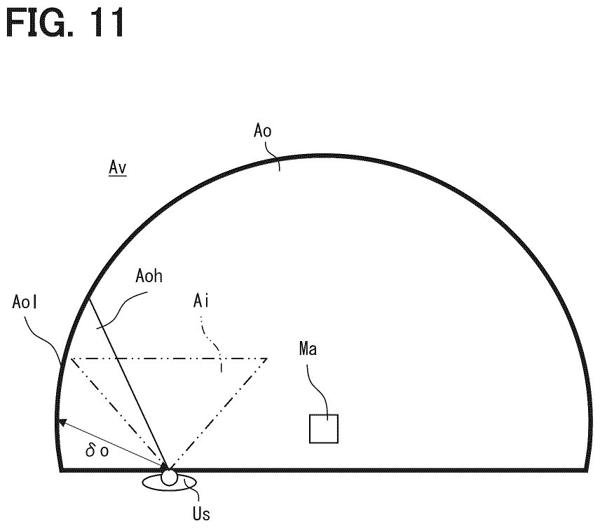

When a negative determination is made in S420, in S440 of the adjustment subroutine shown in FIG. 6, the display control block 220 acquires external sensing information Io sensed by the sensor unit 4 of the autonomous mobile device Ma. The acquisition range of external sensing information Io obtained by the sensor unit 4 with an acceptable level of accuracy or reliability is set to an external sensing space Ao, which is a part of the visible area Av as shown in FIG. 11. The external sensing space Ao is set to be broader than the internal sensing space Ai. Therefore, the external sensing information Io acquired for the external sensing space Ao may be obtained from at least one of sensors included in the sensor unit 4, such as a camera, LiDAR, and sonar.

In S440, as the external sensing information Io of the external sensing space Ao, three-dimensional space information It may be obtained from the infrastructure database Di via the communication system 10 together with the sensing information obtained by the sensor unit 4. That is, the external sensing information Io may be three-dimensional spatial information It, which has been collected by the infrastructure system 6 and stored in the infrastructure database Di.

In S440, the external sensing space Ao is defined by multiple voxels Vi whose two-dimensional or three-dimensional distances are assumed to be within a set range, with the autonomous mobile device Ma at the center. Therefore, the set distance that determines the limit range Aol shown in FIG. 11 of the external sensing space Ao may be set to a fixed value, for example, between 6 meters and 20 meters, depending on the specification of the sensor unit 4 and/or the risk requirement for the processing system 1.

In S450 of the adjustment subroutine shown in FIG. 6, the display control block 220 acquires the risk level Lr in the external sensing space Ao of the visible area Av. As shown in FIG. 11, the risk level Lr is defined as an index, and is set to reach the hazard level Lh when the two-dimensional or three-dimensional separation distance δo between the limit range Aol of the external sensing space Ao and the user Us becomes equal to or less than a threshold value. The risk level Lr in the external sensing space Ao is determined to be at a safe level, which is outside of the hazard level Lh, when the distance δo between the limit range Aol of the external sensing space Ao and the user Us is equal to or greater than a threshold value.

In S460 of the adjustment subroutine shown in FIG. 6, the display control block 220 determines whether the risk level Lr in the external sensing space Ao has reached the hazard level Lh that requires output of hazard notification to the moving user Us. The comparison of the risk level Lr with the hazard level Lh may be performed for each voxel Vi in the space where the user service is provided or for each voxel group consisting of multiple voxels Vi.

When a positive determination is made in S460, in S470 of the adjustment subroutine shown in FIG. 6, the display control block 220 identifies a hazard space portion Aoh, which is part of the external sensing space Ao where the risk level Lr has reached the hazard level Lh, as shown in FIG. 11. Multiple voxels Vi whose risk levels Lr reach the hazard level Lh are recognized as the hazard space portion Aoh. In the visible area Av, the display prohibition range in which the superimposed display of the content image 20 is prohibited may be continued toward the far side of the external sensing space Ao, and multiple voxels Vi present at the far side of external sensing space Ao may be recognized as the hazard space portion Aoh (see FIG. 8).

In S470, the display control block 220 adjusts the occupancy rate Rc to an appropriate value within the range of minimum value and maximum value by restricting the hazard space portion Aoh that has reached the hazard level Lh to be removed from the display target range Ad of the content image 20, as shown in FIG. 8, and prohibiting the superimposed display of the content image 20 in the hazard space portion Aoh. As a result, the remaining space portion As having the safety level, which is outside the hazard space portion Aoh in the visible area Av, is set to the display target range Ad of the content image 20. Thus, the content image 20 is permitted to be superimposed on the remaining space portion As, which is outside the hazard space portion Aoh in the visible area Av.

In S470, as shown in FIG. 8, the hazard image 22, which notifies the driver of the risk level Lr being reached the hazard level Lh with warning text and/or a warning color, may be superimposed on the visible area Av. The hazard image 22 may be displayed to notify the user Us, who caused the hazard level Lh in the external sensing space Ao, of an increase of risk level due to his or her approaching the limit range Aol.

In addition to displaying the hazard image 22, in S470, a warning indicating that the risk level Lr has reached the hazard level Lh may be issued by display output from a display unit of the autonomous mobile device Ma or output of a warning light. In S470, a warning that the risk level Lr has reached the hazard level Lh may be output as an audio signal from the display unit of the autonomous mobile device Ma. Upon completion of S470, the current execution of the adjustment subroutine and processing flow is completed.

When a negative determination is made in S460, in S480 of the adjustment subroutine shown in FIG. 6, the display control block 220 adjusts the occupancy rate Rc to the maximum value by permitting the superimposed display of the content image 20 over the entire area within the visible area Av, as shown in FIG. 7, so that the entire visible area is set as the display target range Ad of the content image 20. The content image 20 includes a limitation image 20cl, which indicates the limit range Aol of the ground Mc in the external sensing space Ao, and the limitation image 20cl is displayed in superimposed manner on the visible area Av as shown in FIG. 7. Upon completion of S480, the current execution of the adjustment subroutine and processing flow is completed. In subsequent executions of the processing flow, the limitation image 20cl will continue to be displayed until a positive determination is made in either S420 or S460.

### Effects

The operation effects of the first embodiment will be described below.

In the first embodiment, the visible area Av visually recognized by the user Us through the wearable terminal Wt worn by the user Us is monitored. Therefore, the occupancy rate Rc of the display target range Ad for displaying the content image 20 relative to the visible area Av is adjusted according to the risk level Lr in the visible area Av. The content image is superimposed on the visible area Av as the XR image corresponding to the required content Cd required by the user Us.

According to the first embodiment, external sensing information Io sensed by the autonomous mobile device Ma, which leads the user Us to move toward the visible area Av, is acquired. Then, the risk level Lr based on the external sensing information Io is recognized. This configuration allows effective use of the autonomous mobile device Ma, which guides the user Us, to recognize the risk level Lr within a wide range with respect to the visible area Av toward which the user Us is moving, thereby ensuring the user's safety.

According to the first embodiment, the visible area Av includes the external sensing space Ao, which is a spatial range for which the external sensing information Io is acquired. Within the external sensing space Ao, superimposed display of the content image 20 is prohibited for the h where the risk level Lr has reached the hazard level Lh. According to this configuration, the content image 20 disappears only within the hazard space portion Aoh, which reaches the hazard level Lh and thus requires hazard notification to the user Us who is in the moving state. Further, the occupancy rate Rc can be adjusted such that the content image 20 continues to be superimposed on the visible area Av outside the hazard space portion Aoh. Therefore, it is possible to balance the safety of moving user Us with the continuity of virtual experience.

In the first embodiment, the limitation image 20cl is superimposed on the visible area Av. The limitation image 20cl is displayed as the XR image representing the limit range Aol on the ground Mc in the external sensing space Ao. According to this configuration, the limit range Aol of the external sensing space Ao in which the risk level Lr is recognized is presented to the user Us. Thus, the safety of user Us is ensured by recognizing the risk level Lr in the external sensing space Ao, and the sense of security felt by the user can be ensured. Therefore, by disappearance of the content image 20 only in the hazard space portion Aoh, it is possible to ensure the safety and sense of security of the user Us in balance with the continuity of virtual experience.

In the first embodiment, the internal sensing information Ii sensed by the wearable terminal Wt is acquired, and the risk level Lr based on the internal sensing information Ii is recognized. This configuration allows the wearable terminal Wt to recognize the risk level Lr even within the proximity range of the user Us, thereby ensuring the safety of user Us. When the risk level Lr in the internal sensing space Ai of the visible area Av, which is the acquisition range of the internal sensing information Ii, reaches the hazard level Lh, the superimposed display of the content image 20 is prohibited over the entire visible area Av. This configuration allows intentional adjustment of the occupancy rate Rc within the proximity range of the user Us so as to prioritize safety over the continuity of virtual experience.

According to the first embodiment, the external sensing information Io collected by the infrastructure system 6 may also be acquired together with the external sensing information Io sensed by the autonomous mobile device Ma, and the risk level Lr may be recognized based on such acquired external sensing information Io. According to this configuration, by effectively utilizing not only the autonomous mobile device Ma that performs the guidance function for the user Us, but also the infrastructure system 6, the risk level Lr of the visible area Av can be recognized with high accuracy, thereby ensuring the safety of user Us.

### Second Embodiment

A second embodiment is a modification of the first embodiment.

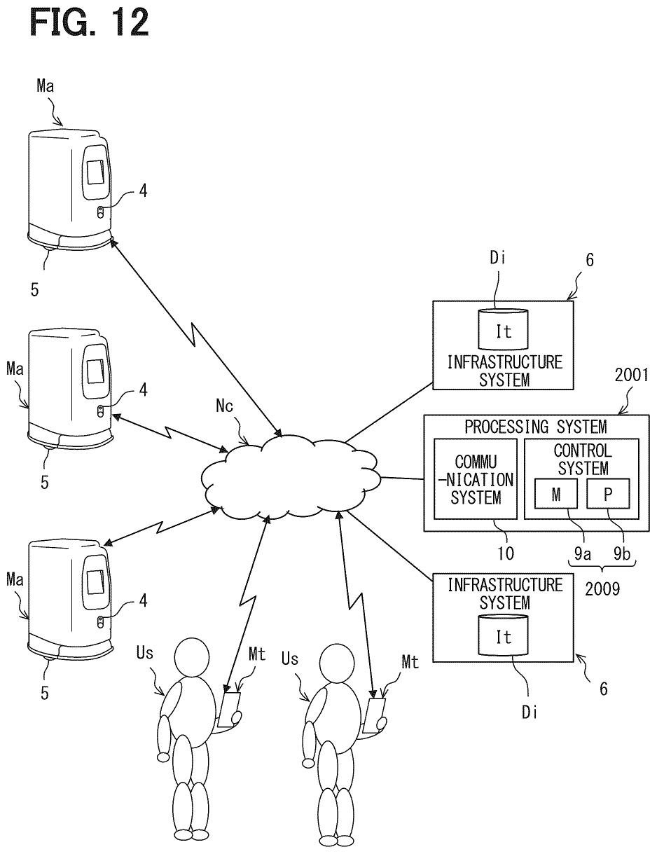

As shown in FIG. 12, a processing system 2001 according to the second embodiment is connected, via the communication network Nc, to a mobile terminal Mt carried by a pre-registered user Us, an autonomous mobile device Ma that performs autonomous traveling, and an infrastructure system 6 that provides infrastructure information. Multiple mobile terminals Mt may be connected to the processing system 2001.

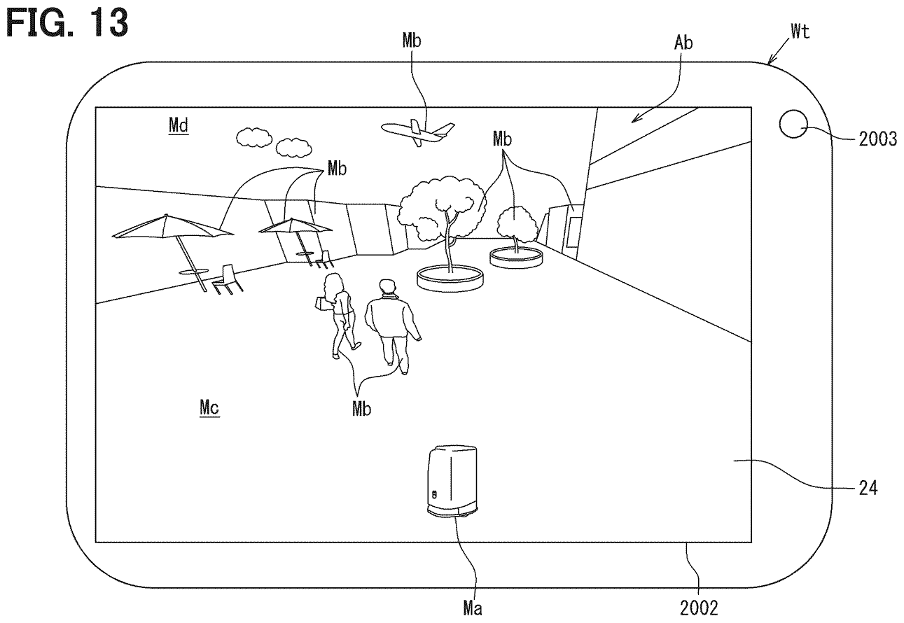

The mobile terminal Mt can be held and operated by the user Us with his or her fingers, at least when connected to the processing system 2001. As shown in FIG. 13, the mobile terminal Mt is a compact electronic device including a display unit 2002 and a sensor unit 2003. For example, the mobile terminal Mt is smartphone or a tablet terminal. As shown in FIG. 12, the mobile terminal Mt controls transmission and reception of data via the communication network Nc by a communication unit. The operation of mobile terminal Mt is controlled by a control unit in accordance with a control command transmitted from the processing system 2001 via the communication network Nc so that the mobile terminal Mt performs a service-related process in cooperation with the processing system 2001.

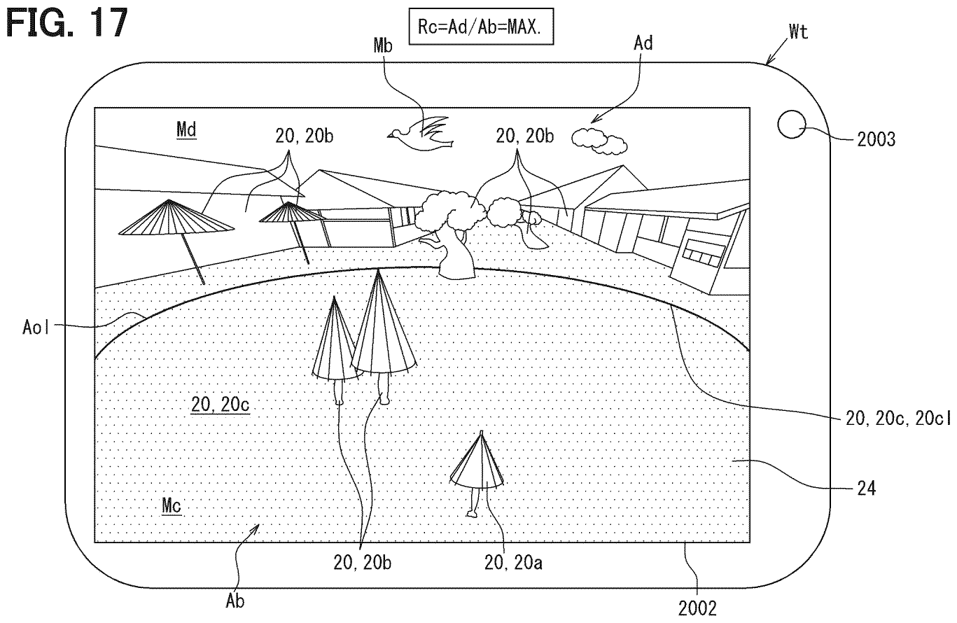

Under the operation control by the control unit of the mobile terminal Mt, the display unit 2002 illustrated in FIG. 13 such as a liquid crystal panel or an organic EL panel implements a screen display (see FIG. 17 to FIG. 19 described later) necessary for the service-related process. Under the operation control of the mobile terminal Mt, the sensor unit 2003 shown in FIG. 13 acquires sensing information by performing a sensing process corresponding to the service-related process. The sensor unit 2003 may be provided by at least one of a camera, an inertial sensor, a Global Navigation Satellite System (GNSS) sensor, a touch sensor, a microphone, or the like. With such a configuration, the sensor unit 2003 can acquire an input representing an intention of the user Us as the sensing information.

The autonomous mobile device Ma shown in FIG. 12 is implemented in the same manner as the first embodiment except that the autonomous mobile device Ma is driven and controlled by the control unit in accordance with the control command from the processing system 2001 via the communication network Nc to execute the service-related process in cooperation with the processing system 2001. A control system 2009 of the processing system 2001 is implemented in the same manner as the control system 9 according to the first embodiment except that at least a part of the control system 2009 may be implemented by the control unit of the mobile terminal Mt and that the control system 2009 executes a processing flow using the mobile terminal Mt, which is to be described later.

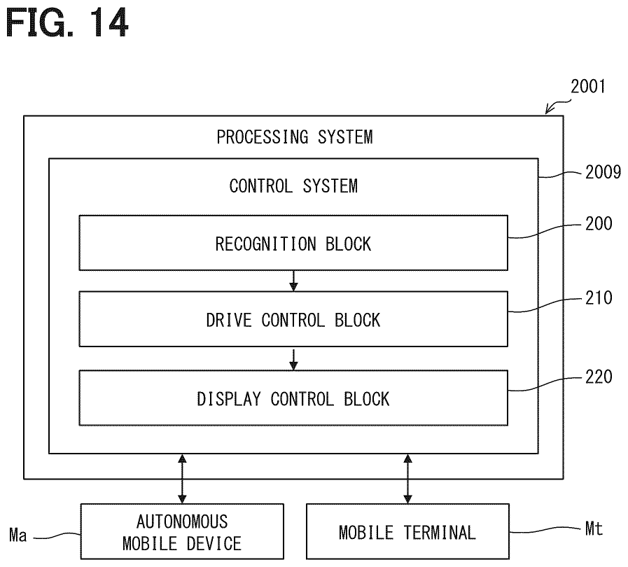

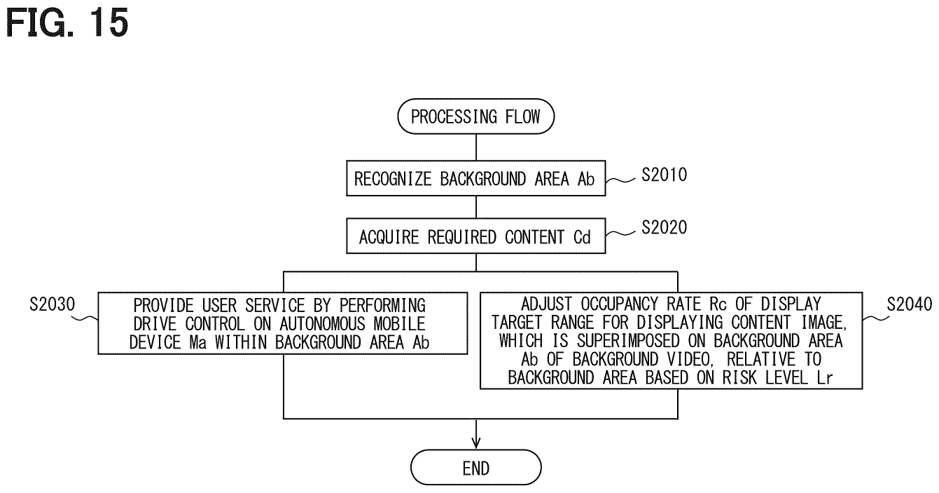

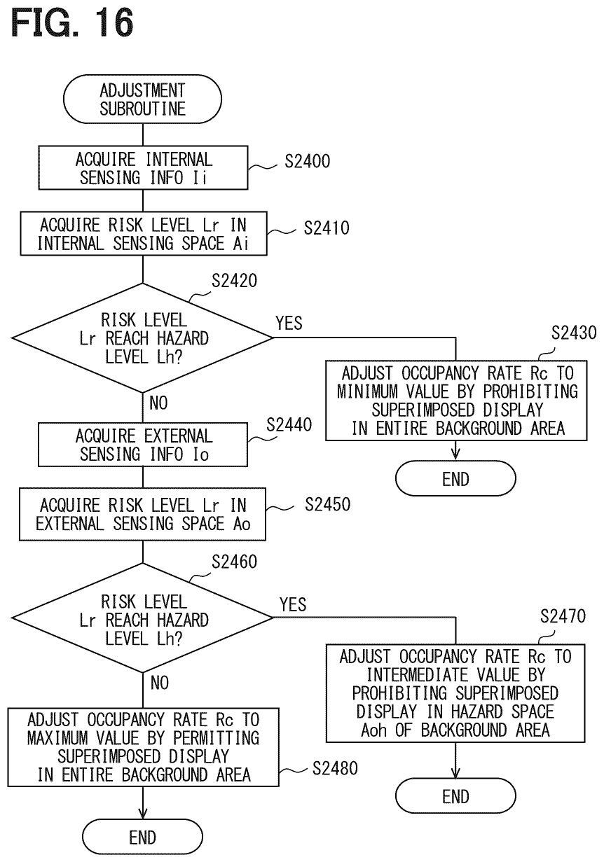

The service-related process is executed by the control system 2009 by performing a processing method in which the processing system 2001 executes an XR display process by cooperation of blocks 200, 210, and 220 constructed as shown in FIG. 14 in accordance with the processing flows shown in FIG. 15 and FIG. 16.

In S2010 of the processing flow shown in FIG. 15, the recognition block 200 (see FIG. 14) monitors a background area Ab, which is the display background of the user Us in the display unit 2002 when the mobile terminal Mt carried by the user Us faces the user. The background area Ab is recognized as an area extending in a direction along which the mobile terminal Mt faces based on at least one type of sensing information such as camera information and inertial information acquired by the sensor unit 2003 of the mobile terminal Mt. During the execution of each step subsequent to S2010 in the processing flow, the latest recognized background area Ab may be updated by executing a monitoring process of the background area Ab in parallel each time the background area Ab changes due to the movements of user Us.

In S2020 of the processing flow shown in FIG. 15, the recognition block 200 acquires the required content Cd. The required content Cd is recognized based on sensing information of the mobile terminal Mt carried by the user Us. The sensing information is used to recognize the required content Cd by being acquired by the mobile terminal Mt at a time when the sensing information is input to the sensor unit 2003 as intention data of the user Us. For details regarding the input and items of the required content Cd, refer to S20 in the first embodiment.

In S2030 of the processing flow shown in FIG. 15, the drive control block 210 (see FIG. 14) controls the drive of the autonomous mobile device Ma existing in the background area Ab, thereby providing user service. A drive control pattern for the autonomous mobile device Ma that matches the type is read from the memory 9a, and the user service is provided in accordance with the drive control pattern so as to guide the user Us to move toward the background area Ab. For details regarding the driving of the autonomous mobile device Ma and the providing of user service, refer to S30 in the first embodiment.

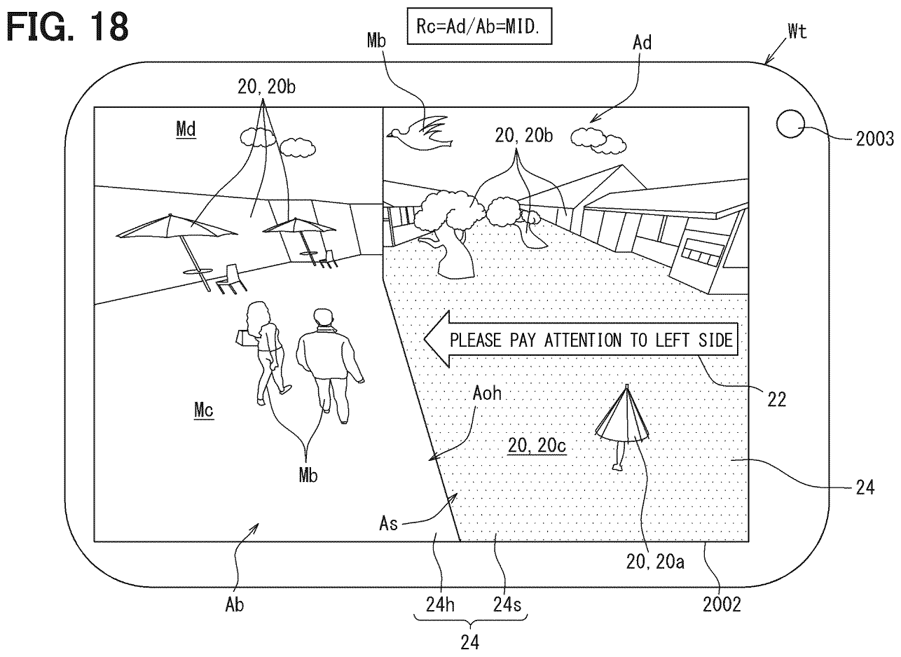

The processing flow shown in FIG. 15 executes S2040 in parallel with S2030. In S2040, the display control block 220 (see FIG. 14) superimposes an XR image corresponding to the required content Cd on the display unit 2002 of the mobile terminal Mt in the background video 24. The background video 24 shows the background area Ab in which the autonomous mobile device Ma exists. As described above, in S2030, the autonomous mobile device Ma provides the user service. The display control block 220 adjusts the occupancy rate Rc of the display target range Ad relative to the background video 24 according to the risk level Lr in the background area Ab. The display target range is a display range of the content image 20, which is the XR image to be superimposed on the background video 24 according to the required content Cd as shown in FIG. 17 and FIG. 18. The occupancy rate Rc in the second embodiment is defined as the ratio of the display area of the entire display target range Ad relative to the display area of the entire background video 24 on the display unit 2002.

In S2040, the background video 24 on which the content image 20 is to be superimposed is acquired based on, for example, sensing information from a sensor unit 4 such as a camera, or three-dimensional space information It acquired from the infrastructure database Di. As the background video 24, primary video data obtained by imaging the background area Ab may be used, or secondary video data obtained by processing the primary data may be used.

In S2040, the content image 20 includes at least the device image 20a shown in FIG. 17 and FIG. 18 as the XR image superimposed on the video portion, corresponding to the location of the autonomous mobile device Ma present in the background area Ab of the background video 24 as shown in FIG. 13. The superimposed display position of the device image 20a is adjusted to match the photographed position of the autonomous mobile device Ma in the background video 24 in accordance with the drive control pattern in S2030. As a result, a replacement display is implemented in which the device image 20a with a display theme corresponding to the required content Cd is superimposed so as to replace the entire autonomous mobile device Ma shown in the background video 24. For details regarding the adjustment of the display position of the device image 20a, refer to S40 in the first embodiment.

The content image 20 in S2040 may include an object image 20b shown in FIG. 17 and FIG. 18 as the XR image to be superimposed on the background video 24. The object image 20b corresponds to the position of another object Mb that exists in the background area Ab together with the autonomous mobile device Ma as shown in FIG. 13. The superimposed display position of the object image 20b is adjusted to match the photographed position of another object Mb on the background video 24, so that the object image 20b is displayed in a similar manner to the device image 20a. For details of another object Mb that replaces the object image 20b, refer to S40 in the first embodiment.

The content image 20 in S2040 may include a ground image 20c shown in FIG. 17 and FIG. 18 as the XR image to be superimposed on the background video 24. The ground image 20c corresponds to the position of ground Mc that exists in the background area Ab together with the autonomous mobile device Ma as shown in FIG. 13. The superimposed display position of the ground image 20c is adjusted to match the photographed position of the ground Mc in the background video 24, similar to the replacement display of the device image 20a.

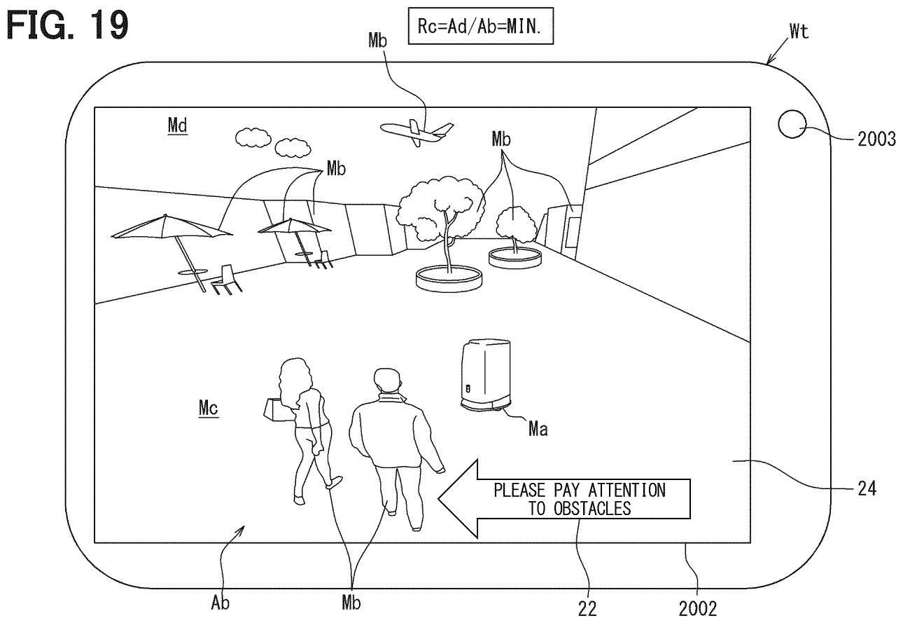

In S2040, the display target range Ad of the content image 20 may be set to the entire background video 24 as shown in FIG. 17, and the occupancy rate Rc is adjusted to the maximum value (for example, 1). In S2040, the display target range Ad of the content image 20 may be set to disappear from the background video 24 as shown in FIG. 19, and the occupancy rate Rc is adjusted to the minimum value (for example, 0). In S2040, the display target range Ad of the content image 20 may be set to a portion of the background video 24 as shown in FIG. 18, and the occupancy rate Rc is adjusted to a value between the minimum value and the maximum value (for example, greater than 0 and less than 1).

In S2040, when hazard notification to the user Us becomes necessary based on the risk level Lr, a hazard image 22, as shown in FIG. 18 and FIG. 19, may be superimposed as the XR image on the ground Mc and/or the sky Md in the background video 24, which is shown in FIG. 13, in the display unit 2002. The superimposed display position of the hazard image 22 may be adjusted to match the photographed position of the ground Mc and/or the sky Md on the background video 24. For details regarding the adjustment of the display position of the hazard image 22, refer to S40 in the first embodiment.

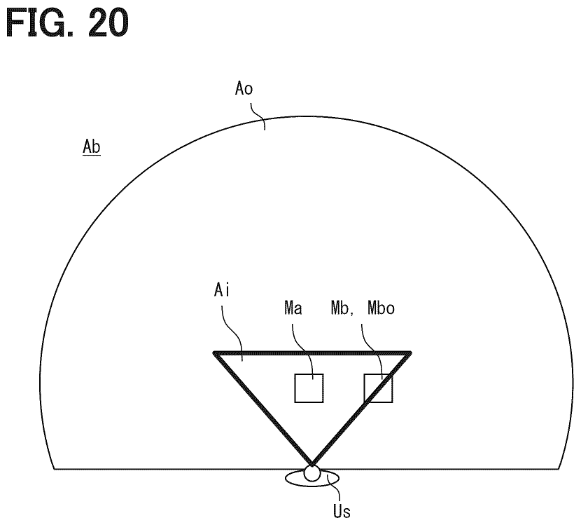

In S2040, an adjustment subroutine is executed as shown in FIG. 16 to switch and adjust the occupancy rate Rc according to the risk level Lr in the background area Ab. Specifically, in S2400 of the adjustment subroutine, the display control block 220 acquires internal sensing information Ii sensed by the sensor unit 2003 of the mobile terminal Mt. The acquisition range of the internal sensing information Ii by the sensor unit 2003 with an acceptable level of accuracy or reliability is set to an internal sensing space Ai that is part of the background area Ab, as shown in FIG. 20. For details regarding the acquisition of internal sensing information Ii and the definition and setting of the internal sensing space Ai, refer to S400 of the first embodiment.

In S2410 of the adjustment subroutine shown in FIG. 16, the display control block 220 acquires the risk level Lr in the internal sensing space Ai of the background area Ab. For details regarding the definition and determination of the risk level Lr, refer to S410 in the first embodiment. In S2420 of the adjustment subroutine, the display control block 220 determines the risk level Lr similar to S410 of the first embodiment.

When a positive determination is made in S2420, in S2430 of the adjustment subroutine shown in FIG. 16, the display control block 220 adjusts the occupancy rate Rc to the minimum value by prohibiting the superimposed display of the content image 20 over the entire area within the background video 24, as shown in FIG. 19, so that the entire visible area is excluded from the display target range Ad of the content image 20. In S2430, a hazard image 22 notifying the driver of the risk level Lr reaching the hazard level Lh may be superimposed on the background video 24 as shown in FIG. 19 with warning text and/or a colored display for warning purpose. For details regarding the display of hazard image 22 and other warning methods, refer to S430 in the first embodiment. Upon completion of S2430, the current execution of the adjustment subroutine and processing flow ends.

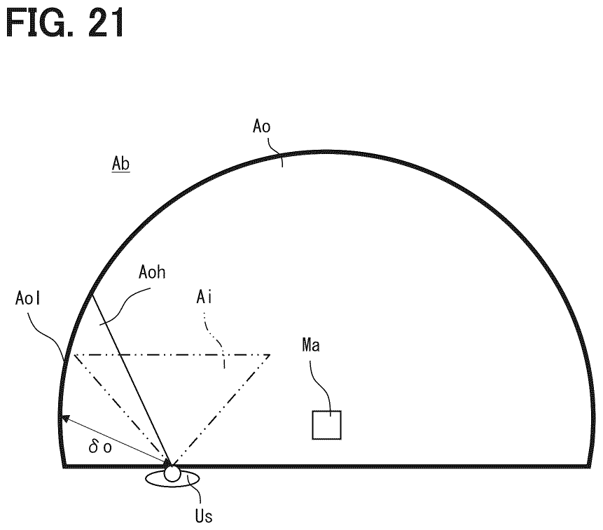

When a negative determination is made in S2420, the display control block 220 acquires the external sensing information Io in S2440 of the adjustment subroutine shown in FIG. 16 similar to S440 of the first embodiment. The acquisition range of external sensing information Io obtained by the sensor unit 4 with an acceptable level of accuracy or reliability is set to an external sensing space Ao, which is a part of the background area Ab as shown in FIG. 21. The external sensing space Ao is set to be broader than the internal sensing space Ai.

In S2450 of the adjustment subroutine shown in FIG. 16, the display control block 220 acquires the risk level Lr in the external sensing space Ao of the background area Ab. For details regarding the definition and determination of the risk level Lr, refer to S450 in the first embodiment. In S2460 of the adjustment subroutine, the display control block 220 determines the risk level Lr similar to S460 of the first embodiment.

When a positive determination is made in S2460, in S2470 of the adjustment subroutine shown in FIG. 16, the display control block 220 specifies the hazard space portion Aoh of the external sensing space Ao similar to S470 of the first embodiment as shown in FIG. 21. In the background area Ab, the display prohibition range in which the superimposed display of the content image 20 is prohibited may be continued toward the far side of the external sensing space Ao, and multiple voxels Vi present at the far side of external sensing space Ao may be recognized as the hazard space portion Aoh (see FIG. 18).

In S2470, the display control block 220 adjusts the occupancy rate Rc to a value within a range of the minimum value and the maximum value by restricting the superimposed display of the content image 20 to a video portion 24h showing the hazard space portion Aoh of the background video 24 showing the external sensing space Ao, as shown in FIG. 18, so as to exclude the video portion 24h showing the hazard space portion Aoh from the display target range Ad of the content image 20. As a result, the remaining portion 24s of the background video 24 other than the video portion 24h is set to the display target range Ad of the content image 20, corresponding to the safety level remaining space portion As outside the hazard space portion Aoh in the background area Ab, thereby allowing the content image 20 to be displayed in an overlapping manner. For details regarding the display of the hazard image 22 and other warning methods, refer to S470 in the first embodiment. Upon completion of S2470, the current execution of the adjustment subroutine and processing flow ends.

When a negative determination is made in S2460, in S2480 of the adjustment subroutine shown in FIG. 16, the display control block 220 adjusts the occupancy rate Rc to the maximum value by permitting the superimposed display of the content image 20 over the entire area within the background area Ab displayed as the background video 24, as shown in FIG. 17, so that the entire background area is set as the display target range Ad of the content image 20. The content image 20 includes a limitation image 20cl, which indicates the limit range Aol of the ground Mc in the external sensing space Ao, and the limitation image 20cl is displayed in superimposed manner on the background video 24 as shown in FIG. 17. Upon completion of S2480, the current execution of the adjustment subroutine and processing flow ends. In subsequent executions of the processing flow, the limitation image 20cl will continue to be displayed until a positive determination is made in either S2420 or S2460.

### Effects

The operation effects of the second embodiment will be described below.

In the second embodiment, the background area Ab visually recognized by a user Us through the mobile terminal Mt carried by the user Us is monitored. Therefore, in the content image 20 superimposed, as the XR image, on the background video 24 displaying the background area Ab according to the content Cd required by the user Us, the occupancy rate Rc of the display target range Ad relative to the background video 24 is adjusted according to the risk level Lr within the background area Ab.

According to the second embodiment, external sensing information Io sensed by the autonomous mobile device Ma, which leads the user Us to move toward the background area Ab, is acquired. Then, the risk level Lr based on the external sensing information Io is recognized. This configuration allows effective use of the autonomous mobile device Ma, which guides the user Us, to recognize the risk level Lr within a wide range with respect to the background area Ab toward which the user Us is moving, thereby ensuring the user's safety.

According to the second embodiment, the background area Ab includes the external sensing space Ao, which is a spatial range for which the external sensing information Io is acquired. Within the portion of the background video 24 where the external sensing space Ao is displayed, superimposed display of the content image 20 is prohibited when the risk level Lr has reached the hazard level Lh in the hazard space portion Aoh. According to this configuration, in the background video 24, the content image 20 disappears only within a portion 24h corresponding to the hazard space portion Aoh, which reaches the hazard level Lh and thus requires hazard notification to the user Us who is in the moving state. Further, the occupancy rate Rc can be adjusted so that the content image 20 continues to be superimposed on the remaining portion 24s of the background area Ab outside the portion 24s corresponding to the hazard space portion. Therefore, it is possible to balance the safety of moving user Us with the continuity of virtual experience.

In the second embodiment, the limitation image 20cl is superimposed on the background video 24 where the background area Ab is displayed. The limitation image 20cl is displayed as the XR image representing the limit range Aol on the ground Mc in the external sensing space Ao. According to this configuration, the limit range Aol of the external sensing space Ao in which the risk level Lr is recognized is presented to the user Us. Thus, the safety of user Us is ensured by recognizing the risk level Lr in the external sensing space Ao, and the sense of security felt by the user can be ensured. Therefore, by disappearance of the content image 20 only in the portion 24h corresponding to the hazard space portion Aoh, it is possible to ensure the safety and sense of security of the user Us in balance with the continuity of virtual experience.

In the second embodiment, the internal sensing information Ii sensed by the mobile terminal Mt is acquired, and the risk level Lr based on the internal sensing information Ii is recognized. This configuration allows the mobile terminal Mt to recognize the risk level Lr even within the proximity range of the user Us, thereby ensuring the safety of user Us. When the risk level Lr in the internal sensing space Ai of the background area Ab, which is the acquisition range of the internal sensing information Ii, reaches the hazard level Lh, the superimposed display of the content image 20 is prohibited over the entire background video 24 where the background area Ab is displayed. This configuration allows intentional adjustment of the occupancy rate Rc within the proximity range of the user Us so as to prioritize safety over the continuity of virtual experience.

According to the second embodiment, the external sensing information Io collected by the infrastructure system 6 may also be acquired together with the external sensing information Io sensed by the autonomous mobile device Ma, and the risk level Lr may be recognized based on such acquired external sensing information Io. According to this configuration, by effectively utilizing not only the autonomous mobile device Ma that performs the guidance function for the user Us, but also the infrastructure system 6, the risk level Lr of the background area Ab can be recognized with high accuracy, thereby ensuring the safety of user Us.

### Other Embodiments

While multiple embodiments are described above, the present disclosure is not interpreted as being limited to the embodiments and can be applied to various embodiments and combinations without departing from a spirit of the present disclosure.

In a modification of the first or second embodiment, the dedicated computer constituting the control system 9, 2009 of the processing system 1, 2001 may include at least one of a digital circuit or an analog circuit, as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such digital circuits may also include a memory for storing program.

In the modification of the first or second embodiment, the processing system 1, 2001 may not be connected to the infrastructure system 6. In the modification example, sensing information acquired by the components Wt, Ma, Mt connected with the processing system 1, 2001 may be used instead of the three-dimensional spatial information It acquired from the infrastructure database Di.

In the modification of the first or second embodiment, the three-dimensional spatial information It not associated with the voxel Vi may be acquired by the processing system 1, 2001 from the infrastructure database Di. In the modification of the first or second embodiment, two-dimensional grid information may be acquired by the processing system 1, 2001 from the infrastructure database Di instead of the three-dimensional spatial information It.

In the modification of the first embodiment, when the mobile terminal Mt described in the second embodiment is connected to the processing system 1 and functions as a part of the wearable terminal Wt, the processing flow may be executed in response to the sensor unit 2003 acquiring a service request input as the sensing information. In the modification of the first embodiment, when the mobile terminal Mt described in the second embodiment is connected to the processing system 1 and functions as a part of the wearable terminal Wt, the required content Cd may be acquired based on the sensing information acquired by the sensor unit 2003 in S20 of the processing flow.

In the modification of the second embodiment, a smart watch or a video see-through or non-transmissive wearable terminal may be used as the mobile terminal Mt. In the modification of the second embodiment, when the wearable terminal Wt described in the first embodiment is connected to the processing system 2001 and functions as a part of the mobile terminal Mt, the processing flow may be executed in response to the sensor unit 3 acquiring a service request input as the sensing information. In the modification of the second embodiment, when the wearable terminal Wt described in the first embodiment is connected to the processing system 2001 and functions as a part of the mobile terminal Mt, the required content Cd may be acquired based on the sensing information acquired by the sensor unit 3 in S2020 of the processing flow.

In a modification example of the first and second embodiments, the display of limitation image 20cl may be omitted in S480 and S2480. In a modification example of the first and second embodiments, the limitation image 20cl may be displayed in the display target range Ad of the content image 20 in S470 and S2470. In a modification example of the first embodiment, in S430 when the risk level Lr in the internal sensing space Ai reaches the hazard level Lh, the superimposed display of the content image 20 may be prohibited only within the internal sensing space Ai of the visible area Av. In a modification example of the second embodiment, in S2430 when the risk level Lr in the internal sensing space Ai reaches the hazard level Lh, the superimposed display of the content image 20 may be prohibited only in the video portion of the background area Ab that corresponds to the internal sensing space Ai.

In addition to the forms described above, the foregoing embodiments and variations may be implemented in the form of a semiconductor device (for example, a semiconductor chip) functioning as the processing system 1, 2001 having at least one processor 9b and at least one memory 9a configuring the control system 9, 2009.

What is claimed is:

1. A processing system that executes an extended reality (XR) display related process for displaying an XR image to a user who is in a moving state,
the processing system comprising at least one of (i) a circuit and (ii) a processor with a memory storing computer program code executable by the processor, the at least one of the circuit and the processor configured to cause the processing system to:
monitor a visible area, which is visible by the user through a wearable terminal worn by the user;
adjust an occupancy rate of a display target range for displaying a content image relative to the visible area in accordance with a risk level in the visible area, the content image being superimposed on the visible area as the XR image in response to a content required by the user;
acquire, for an external sensing space that is a part of the visible area, external sensing information sensed by an autonomous mobile device, which guides the user to move toward the visible area;
recognize the risk level in the visible area based on the acquired external sensing information; and
in the external sensing space, in response to the risk level in a hazard space portion increasing to a predetermined hazard level that requires a hazard notification to the user, adjust the occupancy rate of the display target range relative to the visible area by prohibiting a superimposed display of the content image in the hazard space portion.

2. The processing system according to claim 1, wherein the at least one of the circuit and the processor is further configured to
superimpose, as the XR image in the visible area, a limitation image, which represents a limit range of a ground displayed in the external sensing space.

3. The processing system according to claim 1, wherein the at least one of the circuit and the processor is further configured to:
acquire, for an internal sensing space that is a part of the visible area, internal sensing information sensed by the wearable terminal;
recognize the risk level in the visible area based on the acquired internal sensing information; and
in the internal sensing space, in response to the risk level increasing to the predetermined hazard level that requires the hazard notification to the user who is in the moving state, adjust the occupancy rate of the display target range relative to the visible area by prohibiting a superimposed display of the content image in entire part of the visible area.

4. The processing system according to claim 1, wherein the at least one of the circuit and the processor is further configured to
recognize the risk level based on external sensing information collected by an infrastructure system, in addition to the external sensing information sensed by the autonomous mobile device.

5. A processing system that executes an extended reality (XR) display related process for displaying an XR image to a user who is in a moving state,
the processing system comprising at least one of (i) a circuit and (ii) a processor with a memory storing computer program code executable by the processor, the at least one of the circuit and the processor configured to cause the processing system to:
monitor a background area, which is displayed as background video of a mobile terminal when the user who carries the mobile terminal is oriented to the mobile terminal;
adjust an occupancy rate of a display target range for displaying a content image relative to the background area in accordance with a risk level in the background area, the content image being superimposed on the background area as the XR image in response to a content required by the user;
acquire, for an external sensing space that is a part of the background area, external sensing information sensed by an autonomous mobile device, which guides the user to move toward the background area;
recognize the risk level in the background area based on the acquired external sensing information; and
in the external sensing space, in response to the risk level in a hazard space portion increasing to a predetermined hazard level that requires a hazard notification to the user, adjust the occupancy rate of the display target range relative to the background area by prohibiting a superimposed display of the content image in the hazard space portion.

6. The processing system according to claim 5, wherein the at least one of the circuit and the processor is further configured to
superimpose, as the XR image in the background area, a limitation image, which represents a limit range of a ground displayed in the external sensing space.

7. The processing system according to claim 5, wherein the at least one of the circuit and the processor is further configured to:
acquire, for an internal sensing space that is a part of the background area, internal sensing information sensed by the mobile terminal;
recognize the risk level in the background area based on the acquired internal sensing information; and
in the internal sensing space, in response to the risk level increasing to the predetermined hazard level that requires the hazard notification to the user who is in the moving state, adjust the occupancy rate of the display target range relative to the background area by prohibiting a superimposed display of the content image in entire part of the background area.

8. The processing system according to claim 5, wherein the at least one of the circuit and the processor is further configured to
recognize the risk level based on external sensing information collected by an infrastructure system, in addition to the external sensing information sensed by the autonomous mobile device.

9. A processing method executed by a processor for performing an extended reality (XR) display related process that displays an XR image to a user who is in a moving state, the processing method comprising:
monitoring a visible area, which is visible by the user through a wearable terminal worn by the user;
adjusting an occupancy rate of a display target range for displaying a content image relative to the visible area in accordance with a risk level in the visible area, the content image being superimposed on the visible area as the XR image in response to a content required by the user;
acquiring, for an external sensing space that is a part of the visible area, external sensing information sensed by an autonomous mobile device, which guides the user to move toward the visible area;
recognizing the risk level in the visible area based on the acquired external sensing information; and
in the external sensing space, in response to the risk level in a hazard space portion increasing to a predetermined hazard level that requires a hazard notification to the user, adjusting the occupancy rate of the display target range relative to the visible area by prohibiting a superimposed display of the content image in the hazard space portion.

10. A processing method executed by a processor for performing an extended reality (XR) display related process that displays an XR image to a user who is in a moving state, the processing method comprising:
monitoring a background area, which is displayed as background video of a mobile terminal when the user who carries the mobile terminal is oriented to the mobile terminal;
adjusting an occupancy rate of a display target range for displaying a content image relative to the background area in accordance with a risk level in the background area, the content image being superimposed on the background area as the XR image in response to a content required by the user;
acquiring, for an external sensing space that is a part of the background area, external sensing information sensed by an autonomous mobile device, which guides the user to move toward the background area;
recognizing the risk level in the background area based on the acquired external sensing information; and
in the external sensing space, in response to the risk level in a hazard space portion increasing to a predetermined hazard level that requires a hazard notification to the user, adjusting the occupancy rate of the display target range relative to the background area by prohibiting a superimposed display of the content image in the hazard space portion.

11. A non-transitory computer readable storage medium storing a processing program for performing an extended reality (XR) display related process that displays an XR image to a user who is in a moving state, the processing program comprising instructions for causing a processor to:
monitor a visible area, which is visible by the user through a wearable terminal worn by the user;
adjust an occupancy rate of a display target range for displaying a content image relative to the visible area in accordance with a risk level in the visible area, the content image being superimposed on the visible area as the XR image in response to a content required by the user;
acquire, for an external sensing space that is a part of the visible area, external sensing information sensed by an autonomous mobile device, which guides the user to move toward the visible area;
recognize the risk level in the visible area based on the acquired external sensing information; and
in the external sensing space, in response to the risk level in a hazard space portion increasing to a predetermined hazard level that requires a hazard notification to the user, adjust the occupancy rate of the display target range relative to the visible area by prohibiting a superimposed display of the content image in the hazard space portion.

12. A non-transitory computer readable storage medium storing a processing program for performing an extended reality (XR) display related process that displays an XR image to a user who is in a moving state, the processing program comprising instructions for causing a processor to:
monitor a background area, which is displayed as background video of a mobile terminal when the user who carries the mobile terminal is oriented to the mobile terminal;
adjust an occupancy rate of a display target range for displaying a content image relative to the background area in accordance with a risk level in the background area, the content image being superimposed on the background area as the XR image in response to a content required by the user;
acquire, for an external sensing space that is a part of the background area, external sensing information sensed by an autonomous mobile device, which guides the user to move toward the background area;
recognize the risk level in the background area based on the acquired external sensing information; and
in the external sensing space, in response to the risk level in a hazard space portion increasing to a predetermined hazard level that requires a hazard notification to the user, adjust the occupancy rate of the display target range relative to the background area by prohibiting a superimposed display of the content image in the hazard space portion.
